(19) United States
(12) Patent Application Publication
(10) Pub. No.: US 2021/0019739 A1
(43) Pub. Date: Jan. 21, 2021

(54) TRANSFER GATEWAY SYSTEMS AND METHODS WITH PROLONGED VETTING OF NEW PARTICIPANTS

(71) Applicant: Coinme, Inc., Seattle, WA (US)

(72) Inventors: Francisco ALMONTE, Olympia, WA (US); Russ WIRTZ, Seattle, WA (US); Michael BRADLEY, Olympia, WA (US); Sung CHOI, Seattle, WA (US); Neil BERGQUIST, Seattle, WA (US)

(21) Appl. No.: 16/517,395

(22) Filed: Jul. 19, 2019

(51) Int. Cl. G06Q 20/38; G06Q 20/18; G06Q 20/40; H04L 9/06

(52) U.S. Cl. CPC G06Q 20/382; G06Q 20/18; H04L 2209/56; H04L 9/0643; H04L 2209/38; G06Q 20/4016

(57) ABSTRACT

Systems and methods are disclosed that cause a transient exchange ratio between digital assets at a kiosk, together with a countdown timer or other indication of how much time remains within which the ratio applies. If a transaction proceeds a voucher may be dispensed to confirm it. If a transaction participant using the kiosk is not yet vetted, the transaction is nevertheless deemed inchoate, and a prolonged vetting begins.

### RELATED APPLICATIONS

None

### BRIEF DESCRIPTION OF THE DRAWINGS

FIG. 1 schematically illustrates a system in which respective distributed ledger nodes interact according to one or more improved technologies.

FIG. 2 schematically illustrates a system in which transaction security is enhanced, in which one or more improved technologies may be incorporated.

FIG. 4 depicts a client device in which one or more improved technologies may be incorporated.

FIG. 5 depicts a distributed ledger verification device in which one or more improved technologies may be incorporated.

FIG. 6 depicts a server in which one or more improved technologies may be incorporated.

FIG. 7 depicts another system in which transaction security is enhanced, in which one or more improved technologies may be incorporated.

FIG. 8 depicts special-purpose transistor-based circuitry in which one or more improved technologies may be incorporated.

FIG. 9 depicts an operational flow in which one or more improved technologies may be incorporated.

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote file servers, computer servers and memory storage devices.

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Above,” “accepted,” “acknowledged,” “actual,” “after,” “aggregated,” “allowed,” “apparent,” “associated,” “at,” “automatic,” “based,” “before,” “being,” “between,” “by,” “caused,” “changed,” “completed,” “conditional,” “configured,” “corresponding,” “cryptographic,” “defined,” “defined,” “described,” “determined,” “differing,” “digital,” “disclosed,” “dispensed,” “distributed,” “eligible,” “enhanced,” “established,” “first,” “for,” “from,” “human,” “identified,” “in association with,” “in relation to,” “inchoate,” “included,” “indicative,” “initial,” “invoked,” “last,” “less than,” “likewise,” “local,” “longer,” “manifesting,” “many,” “matching,” “more,” “offered,” “offline,” “older,” “online,” “onto,” “partial,” “particular,” “performed,” “physical,” “potential,” “presented,” “prior,” “probabilistic,” “prolonged,” “public,” “qualified,” “received,” “recent,” “related,” “remaining,” “remote,” “requested,” “respective,” “responsive,” “said,” “scalar,” “second,” “sequential,” “several,” “shorter,” “signaling,” “substantive,” “swiftly,” “tangible,” “to,” “transferred,” “transformed,” “transiently,” “transmitting,” “true,” “updated,” “upon,” “vetted,” “via,” “wherein,” “within,” or other such descriptors herein are used in their normal yes-or-no sense, not merely as terms of degree, unless context dictates otherwise. In light of the present disclosure those skilled in the art will understand from context what is meant by “remote” and by other such positional descriptors used herein. Likewise they will understand what is meant by “partly based” or other such descriptions of dependent computational variables/signals. As used herein a mathematical value or other characteristic is “defined” by one or more tangible phenomena that make it true, whether or not it is estimated, positioned, or otherwise artificially obtained or used. In contrast a mathematical value or other characteristic is “established” only when it is estimated, used as a determinant, or otherwise deliberately obtained (e.g. as a directly presented or otherwise graphically presented quantity, operating parameter, or other physical signal). As used herein two values are “within an order of magnitude” if they differ by less than a factor of ten. As used herein a protocol or other regimen component is “probabilistic” if it includes at least one random or pseudo-random-selection (e.g. in a structured dialog or other required user task).

As used herein and consistent with common parlance, circuitry in situ may be “invoked” by initializing it or otherwise providing digital or other signals into it so as to trigger one or more executions of an operation by which the circuitry is identified. Each instance of circuitry identified as “transistor-based” herein is fully described and enabled by teachings herein so that one of ordinary skill in the art can make and use such circuitry in various inventive configurations without any undue experimentation.

In light of the present disclosure those skilled in the art will understand from context what is meant by “remote” and by other such positional descriptors used herein. Likewise they will understand what is meant by “partly based” or other such descriptions of dependent computational variables/signals. “Numerous” as used herein refers to more than one dozen. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

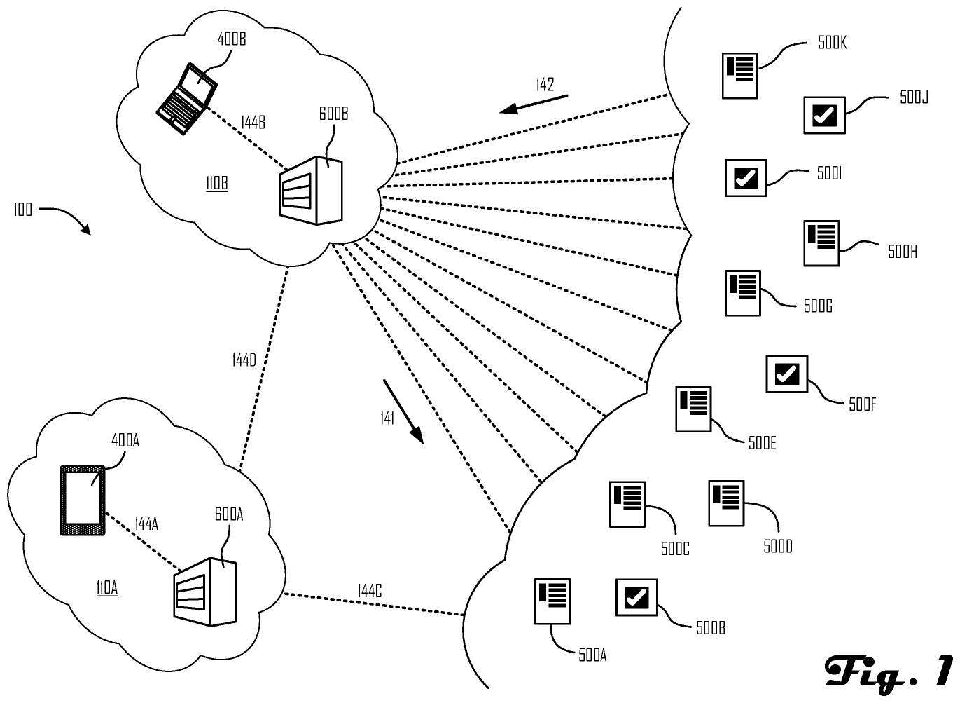

FIG. 1 schematically illustrates a system 100 in which respective entities 110A-B interact with one another and with participating mining rigs (as blockchain node device 500K or similar distributed node devices 500A-J many of which are, at various times, able to implement a cryptoasset transfer or other transaction 141 or to confirm such occurrences as described below (e.g. by one or more confirmations 142). In some variants a private entity 110A comprises one or more node management servers 600A that interact with one or more client devices 400A thereof (e.g. via respective instances of linkage 144A). Likewise a public or collective entity 110B comprises one or more node management servers 600B that interact with one or more client devices 400B thereof (e.g. via respective instances of linkage 144B). In some instances (e.g. in response to interactions via linkages 144C-D) the entities 110A-B may cooperate so that updates (e.g. indicia of dispensations, distributed ledger recordations, or other events) to values maintained at (one or more instances of) server 600B are received and so that adequately timely confirmations to those updates can occur in a decentralized fashion. In an instance where a node is distributed across multiple servers 600B in a proof-of-work architecture, for example, numerous proof-of-work blockchain node devices 500A, 500C, 500D, 500E, 500G, 500H, 500K (e.g. each implementing a mining rig) may validate changes thereof (e.g. by correctly identifying which block was added last) so as to maintain or rebuild consensus. Alternatively or additionally, such consensus may be maintained or rebuilt using numerous (proof-of-stake or other) secure blockchain node devices 500B, 500F, 500I, 500J not configured as a mining rig may validate changes to a particular node in other blockchain proof architectures currently in public use.

As used herein, a plain reference numeral (e.g. like 500) may refer generally to a member of a class of items (e.g. like computing devices) exemplified with a hybrid numeral (e.g. like 500A) and it will be understood that every item identified with a hybrid numeral is also an exemplar of the class. Moreover although a reference numeral shared between figures refers to the same item, most figures depict respective embodiments.

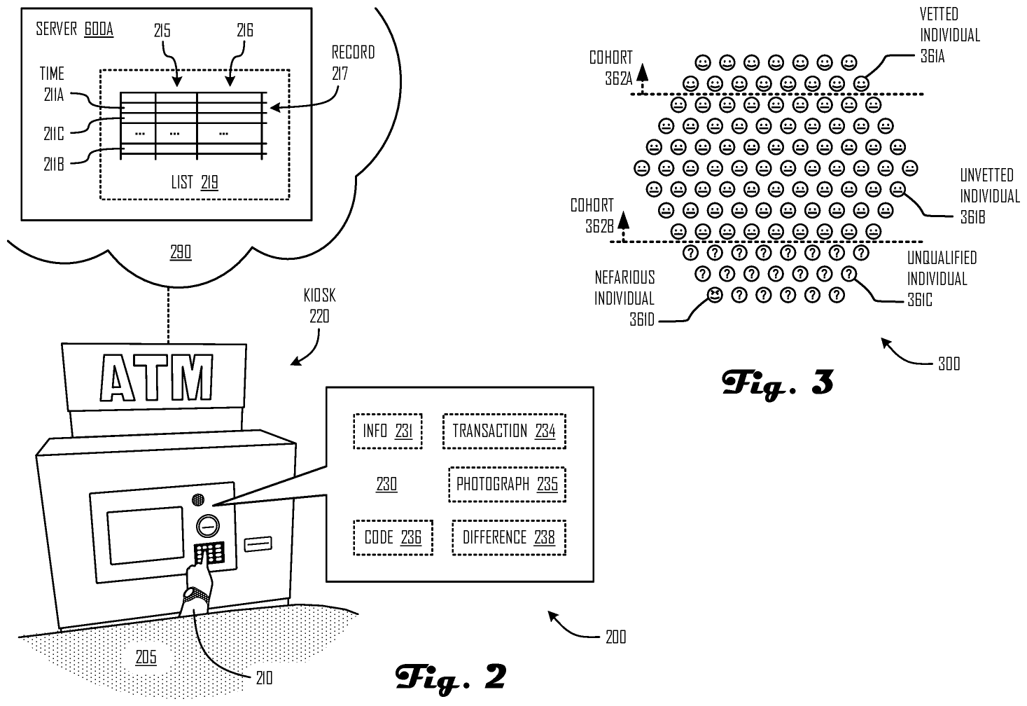

FIG. 2 illustrates a system 200 in which transaction security is enhanced according to one or more improved technologies. As shown a participant 210 to (at least) a first transaction 234 is aboard a motor vehicle 205 that is stopped (e.g. in a driving lane) adjacent a drive-up kiosk 220 in which special-purpose transistor-based circuitry is configured to prompt the participant for an identification of destination and source digital assets (e.g. by offering participant 210 an option of “buy Bitcoin with dollars” or “buy Bitcoin with Ethereum”). Transient exchange rate information 231 that directly or otherwise suggests a for-the-moment exchange ratio “R1” therebetween is presented via the kiosk 220. The participant directly or otherwise specifies a quantity of the source digital asset such as by depositing currency or a gift card while being informed of a limited remaining transaction time that generally decreases (e.g. from a displayed maximum value “M”) while R1 is frozen. Once the participant 210 commits, one or more security codes 236 (a redeem code or pin code, e.g.) are associated with the amount 751 of the first (type of) asset that the participant 210 has decided to acquire. Moreover if the participant 210 is unrecognized by the kiosk 220 at that time, a programmatic recipient vetting regimen begins by which recipient-qualifying information 216 or other data 230 is gathered. By allowing, providing, or otherwise facilitating suitable “first” information 231 (e.g. a photograph 235, phone number, email address, other components as described below, or a combination thereof) the transaction participant 210 becomes “qualified” to participate in the transaction 234. In some variants, for example, one or more records 217 the applicable regimen's structured dialog including one or more queries 215 presented to the participant, identifying information 216 provided in response, and respective times 211A-C at which such components were added to a list 219 (e.g. resident at one or more remote servers 600A, elsewhere on the network 290, or within kiosk 220). By virtue of context-appropriate sequencing of intake of a new participant 210, it is contemplated that a difference 238 between a first and last times 211A-B of such prolonged vetting may far exceed the vetting portion that occurs with the participant 210 at the kiosk 220 (e.g. with the difference 238 exceeding the limited maximum duration “M” by a factor of 2-10 or more). Such operational sequencing allows significant recipient vetting (including know-your-customer and anti-money-laundering protocols, or others without limitation) to occur even after some or all primary transaction terms (including timing, amount, exchange ratio, and recipient identity) are long-since finalized.

FIG. 3 illustrates a differentiated treatment of members of a human population 300 illustrating one aspect of transaction security regimens according to one or more improved technologies. As shown vetted individual 361A in a vetted cohort 362A is able to establish one or more transaction privileges instantly at a given kiosk 220, even before primary transaction terms are defined. A much larger cohort 362B of unvetted individuals 361B (e.g. messengers or family members trusted by a vetted individual 361A) may have a time-critical opportunity to conduct a worthy transaction 234, but no conventional mechanism has heretofore existed which would distinguish them from known nefarious individuals 361D (fugitives, e.g.) or other unqualified individuals 361C (anonymous individuals, e.g.) fast enough to make such transactions 234 viable.

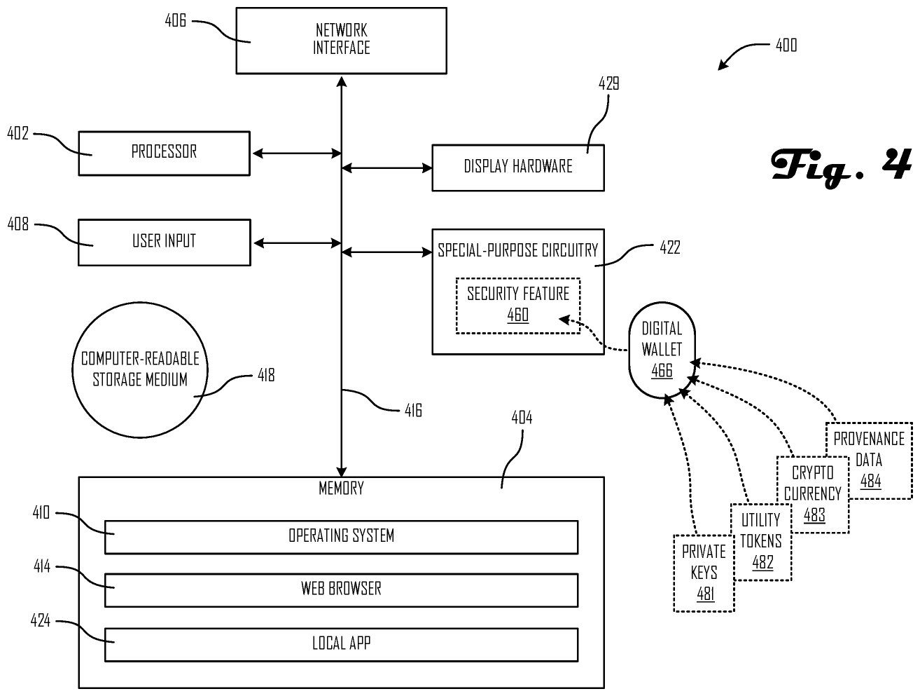

Referring now to FIG. 4, there is shown a client device 400 in which one or more technologies may be implemented. Device 400 may include one or more instances of processors 402, memory 404, user inputs 408, and display hardware 429 all interconnected along with the network interface 406 via a bus 416. One or more network interfaces 406 allow device 400 to connect via the Internet or other networks to or within entities 110 of FIG. 1). Memory 404 generally comprises a random access memory (“RAM”), a read only memory (“ROM”), and a permanent mass storage device, such as a disk drive.

Memory 404 may contain one or more instances of operating systems 410, web browsers 414, and local apps 424. These and other software components may be loaded from a non-transitory computer readable storage medium 418 into memory 404 of the client device 400 using a drive mechanism (not shown) associated with a non-transitory computer readable storage medium 418, such as a floppy disc, tape, DVD/CD-ROM drive, flash card, memory card, or the like. In some embodiments, software components may also be loaded via the network interface 406, rather than via a computer readable storage medium 418. Special-purpose circuitry 422 may, in some variants, include some or all of the event-sequencing logic described below (e.g. in a peer-to-peer implementation) and one or more security features 460 (e.g. a fob or similar security apparatus).

In some contexts security feature 460 may implement or otherwise interact with a removable or other digital wallet 466. Such wallets may (optionally) each include one or more instances of private keys 481, of utility tokens 482, of crypto currency 483, of provenance data 484, or of device-executable code snippets (e.g. smart contracts) or the like as described below. In some embodiments client device 400 may include many more components than those shown in FIG. 4, but it is not necessary that all conventional components be shown in order to disclose an illustrative embodiment.

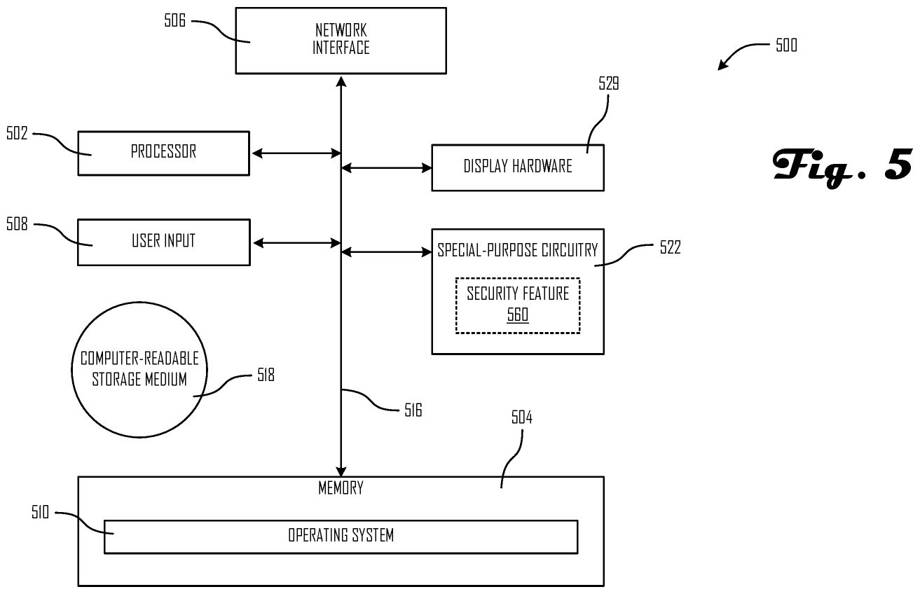

Referring now to FIG. 5, there is shown a distributed ledger verification device 500 like those of FIG. 1. Device 500 may include one or more instances of processors 502, memory 504, user inputs 508, and display hardware 529 all interconnected along with the network interface 506 via a bus 516. One or more network interfaces 506 allow device 500 to connect via the Internet or other networks to or within entities 110 of FIG. 1). Memory 504 generally comprises a random access memory (“RAM”), a read only memory (“ROM”), and a permanent mass storage device, such as a disk drive.

Memory 504 may contain one or more instances of operating systems 510 and special-purpose software. These and other software components may be loaded from a non-transitory computer readable storage medium 518 into memory 504 of the client device 500 using a drive mechanism (not shown) associated with a non-transitory computer readable storage medium 518, such as a floppy disc, tape, DVD/CD-ROM drive, flash card, memory card, or the like. In some embodiments, software components may also be loaded via the network interface 506, rather than via a computer readable storage medium 518. Special-purpose circuitry 522 may, in some variants, include some or all of the event-sequencing logic described below (e.g. in a peer-to-peer implementation) and one or more security features 560 (e.g. specially configured graphics processors or trusted entity private keys). In some embodiments client device 500 may include many more components than those shown in FIG. 5, but it is not necessary that all conventional components be shown in order to disclose an illustrative embodiment.

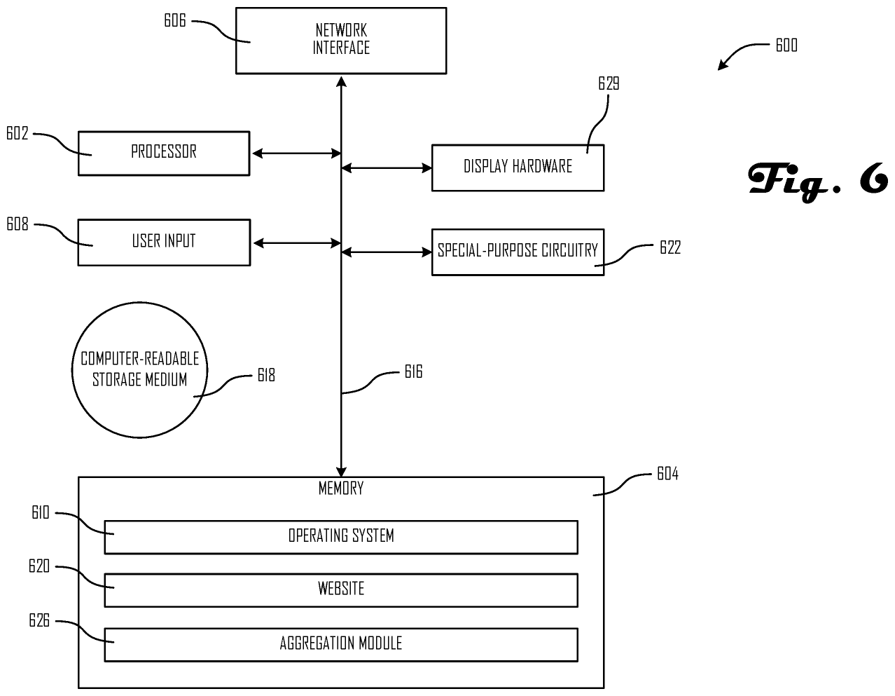

Referring now to FIG. 6, there is shown an exemplary server 600 like those of FIG. 1. Device 600 may include one or more instances of processors 602, memory 604, user inputs 608, and display hardware 629 all interconnected along with the network interface 606 via a bus 616. One or more network interfaces 606 allow device 600 to connect via the Internet or other networks to or within entities 110 of FIG. 1). Memory 604 generally comprises a random access memory (“RAM”), a read only memory (“ROM”), and a permanent mass storage device, such as a disk drive.

Memory 604 may contain one or more instances of operating systems 610, hosted websites 620, and aggregation modules 626. These and other software components may be loaded from a non-transitory computer readable storage medium 618 into memory 604 of the client device 600 using a drive mechanism (not shown) associated with a non-transitory computer readable storage medium 618, such as a floppy disc, tape, DVD/CD-ROM drive, flash card, memory card, or the like. In some embodiments, software components may also be loaded via the network interface 606, rather than via a computer readable storage medium 618. Special-purpose circuitry 622 may, in some variants, include some or all of the event-sequencing logic described below (e.g. in a peer-to-peer implementation) and one or more security features 660 (e.g. a firewall 189). In some embodiments client device 600 may include many more components than those shown in FIG. 6, but it is not necessary that all conventional components be shown in order to disclose an illustrative embodiment.

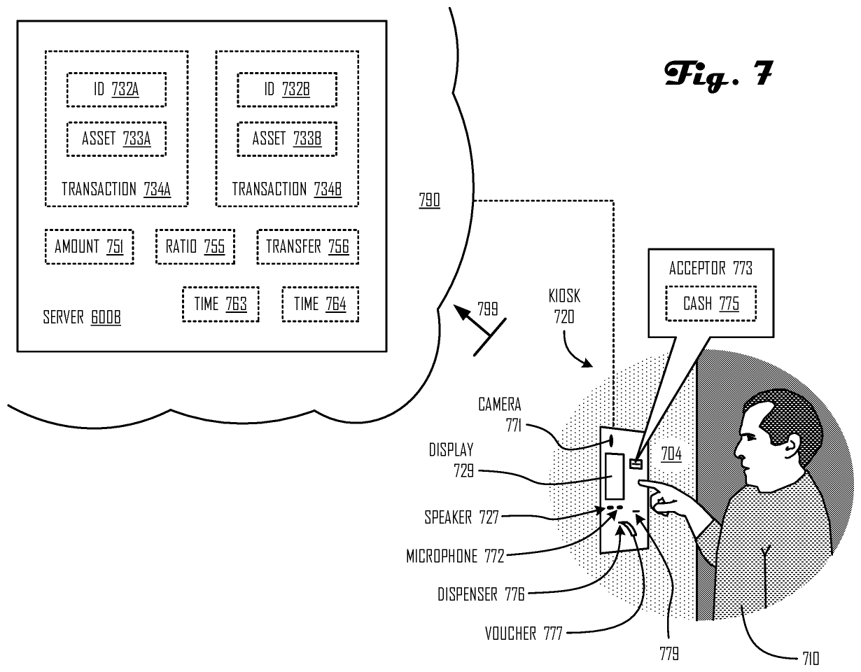

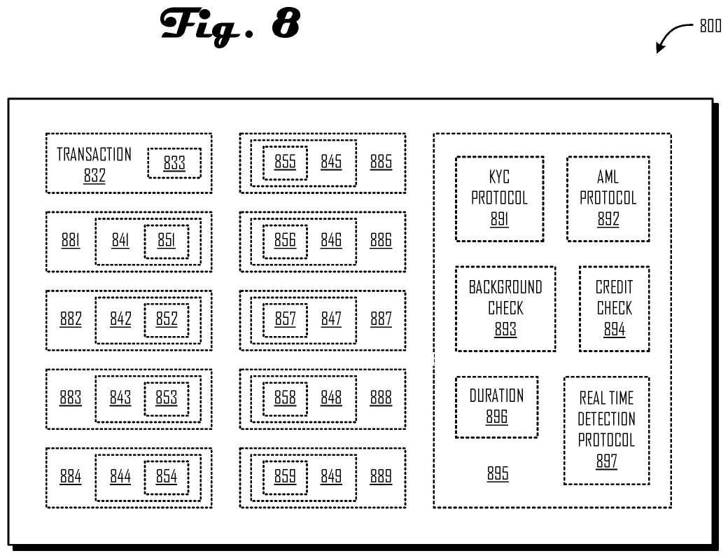

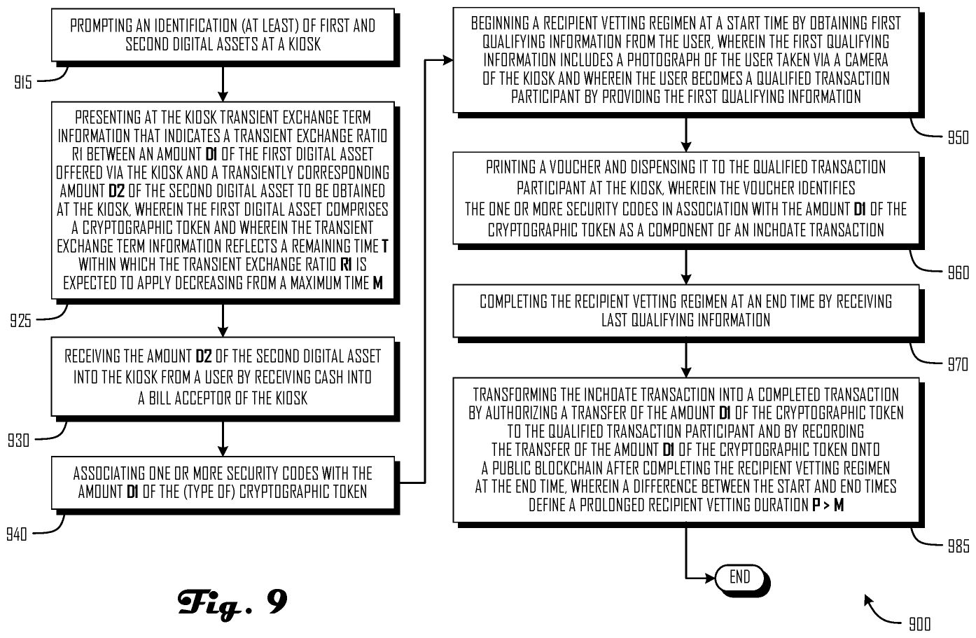

FIG. 7 illustrates a system 700 in which transaction security is enhanced according to one or more improved technologies in which one or more kiosks 220, 720 interact with one or more servers 600B in a part of a network 790 at a remote location 799 (i.e. remote from one or more kiosks 220, 720 that facilitate one or more transfers 756 described herein. As shown an intended recipient 710 is using a kiosk 720 that is (built into a wall or otherwise) a component of a building 704. In some scenarios special-purpose transistor-based circuitry (e.g. see FIGS. 8-9) is configured to prompt such transaction participants 210 for an identification of destination and source digital assets 733 in a first transaction 734A. For example once a would-be recipient 710 selects a natural-language or other identifier 732A of a (type of tentative) destination asset 733A and a similar identifier 732B of a (type of) source asset 733B, a (speaker 727 or display 729 of the) kiosk 720 may prompt the recipient 710 to select a desired (source or destination) amount and may thereafter indicate a ratio 755 therebetween by presenting a transiently corresponding amount 751 of the other asset 733. If a first transaction 734A initially specifies a particular amount 751 of a cryptocurrency or other specific (type of) asset 733A that a user wants to expend, for example, a local presentation module may provide exchange rate information 231 in response by suggesting a specific amount 751 of a destination asset 733B that the recipient 710 can obtain in exchange. Alternatively or additionally if cash 775, checks, gift cards, or other tangible manifestations of the source asset 733B are inserted into a slot 779 or other acceptor 773 and that are thereafter swiftly recognized (e.g. by one or more recognition modules as described below), a quantification thereof may affect the amount 751 of one or more assets 733A of the first transaction 734A.

If the exchange ratio 755 is transient in nature, the kiosk interface may simultaneously notify the user (e.g. by presenting digits or shapes) of a maximum transaction time 764 within which the recipient is expected to commit to the inchoate transaction 734A. Moreover the kiosk 220, 720 may reflect that the remaining transaction time 763 diminishes repeatedly until the inchoate transaction 734A occurs or the remaining transaction time 763 runs out. In some variants the inchoate transaction 734A may culminate in a dispenser 776 generating or otherwise presenting a physical voucher 777 confirming the inchoate transaction 734A. This can occur, for example, in a context in which a transfer 756 of some or all of the destination asset 733B is thereafter assigned (e.g. as a cryptographic utility token transfer 756 or signature/hash function thereof) in a record 217 thereof on a public blockchain;, in which transactions 234 structured in this way enhance security by initiating a timely security regimen that begins by obtaining voice, photographic, or other biometric security data 230 pertaining to a one or more unvetted individuals 361B via a camera 771 or microphone 772 (or both); in which a prolonged recipient vetting duration (e.g. more than double the maximum transaction time 764) allows a more stringent regimen than would otherwise be deemed practical; and in which prolonged recipient vetting durations allow a selection among 2 or more protocols that is probabilistic (e.g. random or pseudorandom) as a prerequisite to maturing the inchoate transaction 734A into one or more complete transactions 734B (e.g. of partial amounts 751 thereof) as a component of an anti-money-laundering (AML) protocol (see FIGS. 8-9).

Referring now to FIG. 8, there is shown a special-purpose transistor-based circuitry 800—optionally implemented as an ASIC or in a UI governance server, for example—in which some or all of the functional modules described herein may be implemented. Transistor-based circuitry 800 includes one or more instances of interaction modules 881, for example, each including an electrical node set 841 upon which informational data is represented digitally as a corresponding voltage configuration 851. Transistor-based circuitry 800 likewise includes one or more instances of presentation modules 882 each including an electrical node set 842 upon which informational data is represented digitally as a corresponding voltage configuration 852. Transistor-based circuitry 800 likewise includes one or more instances of input processing modules 883 each including an electrical node set 843 upon which informational data is represented digitally as a corresponding voltage configuration 853. Transistor-based circuitry 800 likewise includes one or more instances of association modules 884 each including an electrical node set 844 upon which informational data is represented digitally as a corresponding voltage configuration 854. Transistor-based circuitry 800 likewise includes one or more instances of recognition modules 885 each including an electrical node set 845 upon which informational data is represented digitally as a corresponding voltage configuration 855. Transistor-based circuitry 800 likewise includes one or more instances of dispensation modules 886 each including an electrical node set 846 upon which informational data is represented digitally as a corresponding voltage configuration 856. Transistor-based circuitry 800 likewise includes one or more instances of invocation modules 887 each including an electrical node set 847 upon which informational data is represented digitally as a corresponding voltage configuration 857. Transistor-based circuitry 800 likewise includes one or more instances of implementation modules 888 each including an electrical node set 848 upon which informational data is represented digitally as a corresponding voltage configuration 858. Transistor-based circuitry 800 likewise includes one or more instances of output modules 889 each including an electrical node set 849 upon which informational data is represented digitally as a corresponding voltage configuration 859.

In some variants, as described below in the clauses and claims, such a module implements such functionality jointly (e.g. in conjunction with one or more invocation modules 887 or remote processors 502 in a serverless implementation). Alternatively or additionally, in some variants such modules (or components thereof) may be distributed (e.g. so that some are implemented in special-purpose circuitry 622 of respective servers 600) as described above. In some variants transistor-based circuitry 800 may further include one or more instances of know-your-customer (KYC) protocols 891, of anti-money-laundering (AML) protocols 892, of background checks 893 (e.g. scoring or otherwise distilling a criminal, social media, or other relevant history pertaining to a recipient 710 or other participant 210), of credit checks 894 (e.g. obtaining a credit score or otherwise distilling a payment history), of monitoring network-wide phenomena in real time detection protocols 897 (focusing on a modeled Distributed Denial-Of-Service attack or similar nefariously concerted action observed less than one hour ago, e.g.) or other such participant/recipient vetting regimens 895 requiring a prolonged duration 896. Numerous implementations in which computer software instructions or other operational sequences may be useful in such regimens 895 will be evident to one skilled in the art in light of teachings herein. These may include robocall surveys or similar inquiries directed to one or more human information sources, waiting periods, slow-responding information retrieval services, or other such time-consuming measures. As used herein a duration 896 is “prolonged” if it exceeds 3 minutes and also takes longer than maximum time “M” that a corresponding exchange ratio is foreseen to remain open.

FIG. 9 illustrates an operational flow 900 suitable for use with at least one embodiment, such as may be performed (in some variants) on one or more servers 600 using special-purpose circuitry 622 or via smart contracts (or both). As will be recognized by those having ordinary skill in the art, not all events of information management are illustrated in FIG. 9. Rather, for clarity, only those steps reasonably relevant to describing the distributed ledger interaction aspects of flow 900 are shown and described. Those having ordinary skill in the art will also recognize the present embodiment is merely one exemplary embodiment and that variations on the present embodiment may be made without departing from the scope of the broader inventive concept set forth in the clauses and claims below.

Operation 915 describes prompting an identification of first and second digital assets at a kiosk (e.g. one or more interaction modules 881 of transistor-based circuitry 800 implementing a structured dialog that asks a human transaction participant 210 who is using a kiosk 220, 720 to enter an identification 732A-B of two or more types of digital assets 733A-B). This can occur, for example, in a context in which a screen display 729 identifies the (types of) assets 733 with menu options like “buy Bitcoin with US dollars” or “buy Monero with Bitcoin” or “sell Monero for cash” and in which one or more user-provided asset identifications are manifested as a voltage configuration 851 on an electrical node set 841 of (one or more electrical nodes of) such an interaction module 881. Alternatively or additionally, one or more default selections may identify a “first” destination asset and at least one other (source) asset.

Operation 925 describes presenting at the kiosk transient exchange term information that indicates a transient exchange ratio R1 between an amount D1 of the first digital asset offered via the kiosk and a transiently corresponding amount D2 of the second digital asset to be obtained at the kiosk (e.g. one or more presentation modules 882 of transistor-based circuitry 800 presenting at the kiosk 220, 720 transient exchange rate information 231 that directly or otherwise indicates a momentarily frozen “R1” exchange ratio 755 between a “D1” amount 751 of the first digital asset 733B offered to customers and a corresponding “D2” amount 751 of the second digital asset 733A to be received from customers). This can occur, for example, in a context in which the first digital asset comprises a (type of) cryptographic token 833, in which the first transient exchange rate information 231 reflects a remaining time 763 (“T”) within which the “R1” exchange ratio 755 is to be held stable for that particular transaction with that customer, in which the “first” (destination) digital asset 733B comprises a (type of) cryptographic token 833, in which the remaining time 763 is manifested as a voltage configuration 852 on a node set 842 (in video memory 404 of a kiosk 220, 720 implementing a device 400, e.g.) of such a presentation module 882 and decreases from an initial maximum “M” time 764 of several minutes (i.e. between 3 and 10). Alternatively or additionally, the remaining time 763 may be displayed to the customers/user(s) as a countdown timer or as a shrinking bar or wedge presented on a screen display 729.

Operation 930 describes receiving the amount D2 of the second digital asset into the kiosk from a user by receiving cash into a bill acceptor of the kiosk (e.g. one or more processing modules 883 of transistor-based circuitry 800 receiving the “D2” amount of the second digital asset 733A into the kiosk 220, 720 from one or more kiosk users). This can occur, for example, in a context in which paper currency or other cash 775 is received into an acceptor 773 of the first kiosk 220, 720; in which the cash 775 is transformed into the “D2” amount of the second digital asset 733A swiftly upon being received into the bill acceptor 773 (i.e. within thirty seconds the last insertion); and in which the “D2” amount is manifested digitally as a voltage configuration 853 on a node set 843 of such an input processing module 883. Alternatively or additionally, the kiosk 220, 720 may allow a user-identified portion of the deposited amount to be used as the “D2” amount so that a remainder can be used for something else or refunded.

Operation 940 describes associating one or more security codes with the amount D1 of the cryptographic token (e.g. one or more association modules 884 of transistor-based circuitry 800 creating one or more records 217 that associate at least one “redeem” code at least with the “D1” amount 751 of a “first” cryptographic token 833 as the first digital asset 733B). This can occur, for example, during operation 930, 950, or 960 (or more than one of these), wherein the one or more security codes 236 comprise the redeem code. Alternatively or additionally, some records 217 may contain a date code or other recordation of a time 211 in association with one or more other determinants described herein.

Operation 950 describes beginning a recipient vetting regimen at a start time by obtaining first qualifying information from the user (e.g. one or more recognition modules 885 of transistor-based circuitry 800 beginning a first recipient vetting regimen 895 at time 211A by obtaining an initial item of recipient-qualifying information 216 from a kiosk user). This can occur, for example, in a context in which the first qualifying information 216 includes a photograph 235 of one or more users taken via a camera 771 of the kiosk 220, 720; in which the user(s) each become a qualified recipient 710 or other transaction participant 210 by providing such information 216, in which one or more recognition modules 885 verify that the photograph 235 depicts at least one face and a machine-readable state-issued identification (e.g. a driver's license or passport) swiftly; and in which the record 217 is manifested as a voltage configuration 855 on a node set 845 of such a recognition module 885. Alternatively or additionally, the first qualifying information 216 may include a phone number or email address (or both) of an intended asset recipient 710. Those skilled in the art will understand how to configure such recognition modules 885 (e.g. to distinguish valid phone numbers or email addresses from digital noise) in light of teachings herein.

Operation 960 describes printing a voucher and dispensing it to the qualified transaction participant at the kiosk, wherein the voucher identifies the one or more security codes in association with the amount D1 of the cryptographic token as a component of an inchoate transaction (e.g. one or more dispensation modules 886 of transistor-based circuitry 800 printing and dispensing to the first qualified transaction participant 210 at the first kiosk 220, 720 a voucher 777 uniquely identifying a record 217 that establishes the one or more security codes 236 in association with the “D1” amount 751 of the first cryptographic token 833). This can occur, for example, in a context in which a timestamp or other metadata pertaining to the (inchoate) transaction 734A is manifested as a voltage configuration 856 on a node set 846 of such a dispensation module 886 and in which such printing or dispensing (or both) of the voucher 777 is a last phase of the inchoate transaction 734A. In some contexts, the inchoate transaction 734A may be accomplished by a minor, a courier service, or other unvetted transaction participant 210 so that a much larger cohort 362B will be eligible to serve. In some variants, this transaction 734A may occur so rapidly that it may even be completed at a drive-up kiosk 220 without any immediate need to write it to any blockchain nodes 500.

Operation 970 describes completing the recipient vetting regimen at an end time by receiving last qualifying information (e.g. one or more protocol implementation modules 888 of transistor-based circuitry 800 receiving last recipient-qualifying information 216 at end time 211B). This can occur, for example, in a context in which such qualifying information 216 is gathered pursuant to one or more instances of KYC protocols 891, of AML protocols 892, of background checks 893, of credit checks 894, or of other components of a vetting regimen 895 that (unlike the inchoate transaction 734A) require a prolonged duration 896 and in which a distillation result (e.g. signaling an approval, disapproval, or additional requirements) is manifested as a voltage configuration 858 on a node set 848 of such an implementation module 888. Alternatively or additionally, in some regimens 895 such vetting may permit identifying some other individual 361A as a substitute vetted recipient 710.

Operation 985 describes transforming the inchoate transaction into a completed transaction by authorizing a transfer of the amount D1 of the cryptographic token to the qualified transaction participant and by recording the transfer of the amount D1 of the cryptographic token onto a public blockchain after completing the recipient vetting regimen at the end time (e.g. one or more output modules 889 of transistor-based circuitry 800 conditionally authorizing a transfer 756 of the “D1” amount 751 to a cryptographic wallet 466 after the above-referenced vetting and by recording the transfer 756 of the “D1” amount 751 onto dozens or more of cryptographic mining systems as nodes 400 manifesting a public blockchain). This can occur, for example, after completing the first recipient vetting regimen 895 at the first end time 211B, in which the first recipient vetting regimen 895 includes obtaining additional recipient-qualifying information 216 between the first and last recipient-qualifying information 216 (as described above), in which the resulting transfer request or other output (e.g. manifesting one or more transfers 756) is manifested as a voltage configuration 859 on a node set 849 of such an output module 889, in which a difference between the start and end times defines a prolonged recipient vetting duration P>M, and in which a difference 238 between the first start and end times 211A-B defines a prolonged de facto recipient vetting duration 896 that is longer than a day or even a week. Alternatively or additionally, such output may include a batched transfer to several vetted recipients 710 that would not have been possible because at least one of them was unvetted at the time of the corresponding inchoate transaction 734A.

This can occur, for example, in a context in which the second asset 733A is perishable or in other circumstances where committing the second asset 733A (for taxes, insurance coverage, inheritance, medical or other crucial service payments, regulatory or contractual compliance, international asset transfers, or other contexts in which flawed transaction timing has draconian consequences, e.g.); in which such prolonged vetting is a necessity for conducting an adequate KYC protocol 891 or AML protocol 902 (or both) for the category of recipient 710 for whom the inchoate transaction 734A was established; and in which an undesired result (e.g. a hack or similar forfeiture) would otherwise occur instead. Alternatively or additionally, one or more operations like those described above may be performed indirectly, such as by a corresponding instance of an invocation module 887 (e.g. using a memory address or other signal routing mechanism manifested as a voltage configuration 857 on a node set 847 thereof) that activates one or more remote instance of the above-described modules (e.g. in another country or in a cloud/distributed application).

In light of teachings herein, numerous existing techniques may be applied for configuring special-purpose circuitry or other structures effective for configuring and otherwise managing transactions and other operations as described herein without undue experimentation. See, e.g., U.S. Pat. No. 10,268,829 (“Security systems and methods based on cryptographic utility token inventory tenure”); U.S. Pat. No. 10,135,607 (“Distributed ledger interaction systems and methods”); U.S. Pat. No. 9,747,586 (“System and method for issuance of electronic currency substantiated by a reserve of assets”); U.S. Pat. No. 9,672,499 (“Data analytic and security mechanism for implementing a hot wallet service”); U.S. Pat. No. 9,646,029 (“Methods and apparatus for a distributed database within a network”); U.S. Pat. No. 9,569,771 (“Method and system for storage and retrieval of blockchain blocks using Galois fields”); U.S. Pat. No. 9,569,439 (“Context-sensitive query enrichment”); U.S. Pub. No. 20180183687 (“System and Method for Managing Services and Licenses Using a Blockchain Network; U.S. Pub. No. 20180183606 (“Verifying Authenticity of Computer Readable Information Using the Blockchain; U.S. Pub. No. 20180129955 (“Hybrid Blockchain Data Architecture for use Within a Cognitive Environment; U.S. Pub. No. 20170364698 (“Fragmenting data for the purposes of persistent storage across multiple immutable data structures; U.S. Pub. No. 20170287090 (“System and method for creating and executing data-driven legal contracts; U.S. Pub. No. 20170116693 (“Systems and Methods for Decentralizing Commerce and Rights Management for Digital Assets Using a Blockchain Rights Ledger; U.S. Pub. No. 20170109668 (“Model for Linking Between Nonconsecutively Performed Steps in a Business Process; U.S. Pub. No. 20170109639 (“General Model for Linking Between Nonconsecutively Performed Steps in Business Processes; U.S. Pub. No. 20170109638 (“Ensemble-Based Identification of Executions of a Business Process”); U.S. Pub. No. 20160260095 (“Containerized Computational Task Execution Management Using a Secure Distributed Transaction Ledger”); U.S. Pub. No. 20120095908 (“Distributed Computing for Engaging Software Services”); U.S. Pub. No. 20120020476 (“Method for Performing a Cryptographic Task in an Electronic Hardware Component”); and U.S. Pub. No. 20100332336 (“System and method for electronic wallet conversion”).

In particular, numerous existing techniques may be applied for configuring special-purpose circuitry or other structures effective for determining correlations, updating trust-related indicia, allocating tasks, implementing structured dialogs or other regimen components, or other security protocols and functions as described herein without undue experimentation. See, e.g., U.S. Pat. No. 10,121,025 (“Content validation using blockchain”); U.S. Pat. No. 10,282,554 (“System and method for providing a cryptographic platform for exchanging information); U.S. Pat. No. 10,243,743 (“Tokens or crypto currency using smart contracts and blockchains); U.S. Pat. No. 10,213,696 (“Adaptation of gaming applications to participants); U.S. Pat. No. 10,068,397 (“System and method for access control using context-based proof”); U.S. Pat. No. 10,063,568 (“User behavior profile in a blockchain”)U.S. Pat. No. 10,062,108 (“Mobile remittance computer system and method); U.S. Pat. No. 10,037,533 (“Systems and methods for detecting relations between unknown merchants and merchants with a known connection to fraud); U.S. Pat. No. 10,050,959 (“Synthetic genomic variant-based secure transaction devices, systems and methods”)U.S. Pat. No. 9,934,498 (“Facilitating guaranty provisioning for an exchange); U.S. Pat. No. 9,830,646 ( “Credit score goals and alerts systems and methods); U.S. Pat. No. 9,477,988 (“Systems and methods for identifying financial relationships); U.S. Pub. No. 20180332070 (“User Behavior Profile Environment”); U.S. Pub. No. 20180300476 (“Dynamic episodic networks”); U.S. Pub. No. 20180332072 (“User Behavior Profile Including Temporal Detail Corresponding to User Interaction”); U.S. Pub. No. 20180167198 (“Trust Enabled Decentralized Asset Tracking for Supply Chain and Automated Inventory Management”); U.S. Pub. No. 20180157825 (“Systems and Methods for Determining Trust Levels for Computing Components Using Blockchain”); U.S. Pub. No. 20180097841 (“System and method for omnichannel social engineering attack avoidance”); and U.S. Pub. No. 20130061288 (“Method for controlling trust and confidentiality in daily transactions of the digital environment”).

Although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

In the numbered clauses below, specific combinations of aspects and embodiments are articulated in a shorthand form such that (1) according to respective embodiments, for each instance in which a “component” or other such identifiers appear to be introduced (e.g. with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### Clauses

1. A method for enhancing security in one or more cryptographic token transactions 734, the method comprising:

invoking transistor-based circuitry configured to prompt an identification 732A-B of (at least each of) first and second digital assets 733A-B at a first kiosk 220, 720;

invoking transistor-based circuitry configured to present at the first kiosk 220, 720 transient exchange rate information 231 that (directly or otherwise) indicates a transient exchange ratio 755 R1 between an amount 751 of the first digital asset 733B offered via the first kiosk 220, 720 and a transiently corresponding amount 751 of the second digital asset 733A to be obtained via the first kiosk 220, 720, wherein the first digital asset 733B comprises a first (cryptocurrency, utility token 482, or other) cryptographic token 833 and wherein the transient exchange rate information 231 established a remaining transaction time 763 T;

invoking transistor-based circuitry configured to receive the amount 751 of the second digital asset 733A into the first kiosk 220, 720 from a first user;

invoking transistor-based circuitry configured to associate one or more security codes 236 with the amount 751 of the first cryptographic token 833;

invoking transistor-based circuitry configured to begin a recipient vetting regimen 895 at a first start time 211A by obtaining recipient-qualifying information 216 from the first user wherein the first user becomes a qualified transaction participant 210 by providing the recipient-qualifying information 216;

invoking transistor-based circuitry configured to dispense to the qualified transaction participant 210 at the first kiosk 220, 720 a physical or other voucher 777 identifying the one or more security codes 236 in association with the amount 751 of the first cryptographic token 833 as a component of a first inchoate transaction 734A;

invoking transistor-based circuitry configured to complete the recipient vetting regimen 895 at a first end time 211B by receiving last recipient-qualifying information 216; and

invoking transistor-based circuitry configured to transform the first inchoate transaction 734A into a completed transaction 734B (at least partly) by authorizing a first transfer 756 of the amount 751 of the first digital asset 733B, wherein a difference 238 between the first start and end times 211A-B defines a prolonged recipient vetting duration 896 P>M, wherein M was established as a maximum transaction time 764.

2. The method of ANY one of the above method clauses, wherein said invoking said transistor-based circuitry configured to transform the first inchoate transaction 734A into said completed transaction 734B comprises:

authorizing a first transfer 756 of at least some of the amount 751 of the first digital asset 733B to a human recipient 710, wherein at least one anti-money laundering (AML) protocol 892 that includes a probabilistic regimen component selection of the recipient vetting regimen 895 pertaining to the human recipient 710 is made possible by the prolonged recipient vetting duration 896.

3. The method of ANY one of the above method clauses, wherein at least some of the invoking is performed within a drive-up kiosk 220 adjacent (a vehicular traffic lane upon which is) a motor vehicle 205 occupied by the transaction participant 210 at least while the amount 751 of the second digital asset 733A is deposited into the first kiosk 220, 720 from a first user; wherein the drive-up kiosk is or is not the first kiosk 220, 720.

4. The method of ANY one of the above method clauses, comprising:

presenting the transient exchange rate information 231 that indicates the transient exchange ratio 755 R1 between the amount 751 of the first digital asset 733B offered via the kiosk 220, 720 and the transiently corresponding amount 751 of the second digital asset 733A and the remaining transaction time 763 (sequentially or otherwise) on a screen display 729 of the kiosk 220, 720.

5. The method of ANY one of the above method clauses, comprising:

presenting the transient exchange rate information 231 that indicates the transient exchange ratio 755 R1 between the amount 751 of the first digital asset 733B offered via the kiosk 220, 720 and the transiently corresponding amount 751 of the second digital asset 733A and the remaining transaction time 763 both simultaneously on a screen display 729 of the kiosk 220, 720.

6. The method of ANY one of the above method clauses, wherein the invoking the transistor-based circuitry configured to dispense to the qualified transaction participant 210 at the kiosk 220, 720 the voucher 777 identifying the one or more security codes 236 in association with the amount 751 of the first cryptographic token 833 comprises:

printing the one or more security codes 236 identifying the one or more security codes 236 in association with the amount 751 of the first cryptographic token 833 onto the voucher 777 after presenting the transient exchange rate information 231 that indicates the transient exchange ratio 755 R1 between the amount 751 of the first digital asset 733B offered via the kiosk 220, 720 and the transiently corresponding amount 751 of the second digital asset 733A and the remaining transaction time 763 both simultaneously on a screen display 729 of the kiosk 220, 720.

7. The method of ANY one of the above method clauses, wherein the invoking the transistor-based circuitry configured to dispense to the qualified transaction participant 210 at the kiosk 220, 720 the voucher 777 identifying the one or more security codes 236 in association with the amount 751 of the first cryptographic token 833 comprises:

printing the one or more security codes 236 identifying the one or more security codes 236 in association with the amount 751 of the first cryptographic token 833 onto the voucher 777 after presenting the transient exchange rate information 231 that indicates the transient exchange ratio 755 R1 between the amount 751 of the first digital asset 733B offered via the kiosk 220, 720 and the transiently corresponding amount 751 of the second digital asset 733A and the remaining transaction time 763 both simultaneously on a screen display 729 of the kiosk 220, 720 and after receiving the amount 751 of the second digital asset 733A into the kiosk 220, 720 from the first user.

8. The method of ANY one of the above method clauses, wherein the first transfer 756 of the amount 751 of the first digital asset 733B is performed using the one or more security codes 236.

9. The method of ANY one of the above method clauses, wherein said invoking said transistor-based circuitry configured to transform the first inchoate transaction 734A into said completed transaction 734B comprises:

invoking said transistor-based circuitry configured to transform the first inchoate transaction 734A into said completed transaction 734B comprises (at least partly) by authorizing a first transfer 756 of the amount 751 of the first digital asset 733B to a human recipient 710, wherein the human recipient 710 is or is not the qualified transaction participant 210.

10. The method of ANY one of the above method clauses, wherein said invoking said transistor-based circuitry configured to transform the first inchoate transaction 734A into said completed transaction 734B comprises:

invoking said transistor-based circuitry configured to transform the first inchoate transaction 734A into said completed transaction 734B comprises (at least partly) by authorizing a first transfer 756 of the amount 751 of the first digital asset 733B to the qualified transaction participant 210.

11. The method of ANY one of the above method clauses, wherein said invoking said transistor-based circuitry configured to transform the first inchoate transaction 734A into said completed transaction 734B comprises:

invoking said transistor-based circuitry configured to transform the first inchoate transaction 734A into said completed transaction 734B comprises (at least partly) by authorizing a first transfer 756 of the amount 751 of the first digital asset 733B by recording the first transfer 756 of the amount 751 of the first digital asset 733B onto a public blockchain after completing the recipient vetting regimen 895 at the first end time 211B.

12. The method of ANY one of the above method clauses, wherein the recipient vetting regimen 895 includes obtaining first and last recipient-qualifying information 216 relating to respective first and last components of a know-your-customer (KYC) protocol 891 performed upon one or more potential recipients 710 of the first transfer 756 of the amount 751 of the first digital asset 733B, wherein a difference 238 between the start and end times 211A-B defines a prolonged KYC vetting duration 896 P>M.

13. The method of ANY one of the above method clauses, wherein the recipient vetting regimen 895 includes obtaining first and last recipient-qualifying information 216 relating to respective first and last components of an anti-money-laundering (AML) protocol 892 performed upon one or more potential recipients 710 of the first transfer 756 of the amount 751 of the first digital asset 733B, wherein a difference 238 between the start and end times 211A-B defines a prolonged AML vetting duration 896 P>M.

14. The method of ANY one of the above method clauses, wherein the recipient vetting regimen 895 includes obtaining additional recipient-qualifying information 216 between the first and last recipient-qualifying information 216 relating to one or more potential recipients 710.

15. The method of ANY one of the above method clauses, wherein the recipient vetting regimen 895 includes obtaining additional recipient-qualifying information 216 between the first and last recipient-qualifying information 216 as a component of a know-your-customer (KYC) protocol 891.

16. The method of ANY one of the above method clauses, wherein the recipient vetting regimen 895 includes obtaining additional recipient-qualifying information 216 between the first and last recipient-qualifying information 216 as a component of an anti-money-laundering (AML) protocol 892.

17. The method of ANY one of the above method clauses, wherein the recipient vetting regimen 895 includes obtaining additional recipient-qualifying information 216 between the first and last recipient-qualifying information 216 as a component of a criminal background check 893 of one or more potential recipients 710.

18. The method of ANY one of the above method clauses, wherein the recipient vetting regimen 895 includes obtaining additional recipient-qualifying information 216 between the first and last recipient-qualifying information 216 as a component of a credit check 894 of one or more potential recipients 710.

19. The method of ANY one of the above method clauses, comprising:

identifying some other individual 361A as a vetted substitute recipient 710 in the first transfer 756 of the amount 751 of the first digital asset 733B and in lieu of said qualified transaction participant 210.

20. The method of ANY one of the above method clauses, comprising:

identifying some other individual 361A as a vetted substitute recipient 710 in the first transfer 756 of the amount 751 of the first digital asset 733B and in lieu of said qualified transaction participant 210.

21. The method of ANY one of the above method clauses, comprising:

identifying some other individual 361A as a vetted substitute recipient 710 in the first transfer 756 of the amount 751 of the first digital asset 733B as a conditional response to (one or more protocols or other components of) a vetting regimen 895 finding fault with said qualified transaction participant 210.

22. The method of ANY one of the above method clauses, comprising:

identifying some other individual 361 as a substitute recipient 710 in the first transfer 756 of the amount 751 of the first digital asset 733B; and

vetting that other individual 361 after identifying that other individual 361.

23. The method of ANY one of the above method clauses, comprising:

identifying some other individual 361 as a substitute recipient 710 in the first transfer 756 of the amount 751 of the first digital asset 733B as a conditional response to (one or more protocols or other components of) a vetting regimen 895 finding fault with said qualified transaction participant 210; and

vetting that other individual 361 after identifying that other individual 361.

24. The method of ANY one of the above method clauses, comprising:

establishing the maximum transaction time 764 with a value less than 10 hours.

25. The method of ANY one of the above method clauses, comprising:

establishing the maximum transaction time 764 with a value within an order of magnitude of 20 minutes.

26. The method of ANY one of the above method clauses, comprising:

establishing the maximum transaction time 764 with a value less than 1 hour.

27. The method of ANY one of the above method clauses, wherein recording the first transfer 756 of the amount 751 of the first digital asset 733B onto a public blockchain comprises:

recording the first transfer 756 of the amount 751 of the first digital asset 733B onto numerous cryptographic mining systems 400 manifesting a public blockchain

28. The method of ANY one of the above method clauses, wherein the cash 775 is transformed into the amount 751 of the second digital asset 733A swiftly upon (a sole or last component thereof) being received into a bill acceptor 773, wherein the bill acceptor 773 is a component of the kiosk 220, 720.

29. The method of ANY one of the above method clauses, comprising:

identifying said transaction participant 210 by (at least) said recipient-qualifying information 216.

30. The method of ANY one of the above method clauses, comprising:

identifying said transaction participant 210 by (at least) said last recipient-qualifying information 216.

31. The method of ANY one of the above method clauses, wherein said transaction participant 210 is a recipient 710 identified by (at least) said first and said last recipient-qualifying information 216.

32. The method of ANY one of the above method clauses, wherein said authorizing said first transfer 756 of the amount 751 of the first digital asset 733B to said qualified transaction participant 210 comprises:

authorizing a first transfer 756 of the amount 751 of the first digital asset 733B to a cryptographic wallet 466 of the qualified transaction participant 210.

33. The method of ANY one of the above method clauses, wherein said identifying the first security code 236 in association with the amount 751 of the first cryptographic token 833 comprises:

identifying a record 217 that establishes the first security code 236 in association with the amount 751 of the first cryptographic token 833.

34. The method of ANY one of the above method clauses, wherein said voucher 777 identifying the first security code 236 in association with the amount 751 of the first cryptographic token 833 as a component of a first inchoate transaction 734A is dispensed to said qualified transaction participant 210 at the kiosk 220, 720 as a conditional response to said qualified transaction participant 210 acknowledging said transient exchange ratio 755 R1.

35. The method of ANY one of the above method clauses, wherein cash 775 is transformed into the amount 751 of the second digital asset 733A swiftly upon (a sole or last component thereof) being received into a bill acceptor 773.

36. A system 100, 200, 700 for enhancing security in one or more cryptographic token transactions 734, the system comprising:

transistor-based circuitry (e.g. a remote or other instance of an interaction module 881 or local invocation module 887 thereof) configured to prompt an identification 732A-B of first and second digital assets 733A-B at a first kiosk 220, 720; transistor-based circuitry (e.g. a remote or other instance of a presentation module 882 or local invocation module 887 thereof) configured to present at the first kiosk 220, 720 transient exchange rate information 231 that presents or otherwise indicates a transient exchange ratio 755 R1 between an amount 751 of the first digital asset 733B offered via the first kiosk 220, 720 and a transiently corresponding amount 751 of the second digital asset 733A to be obtained via the first kiosk 220, 720, wherein the first digital asset 733B comprises a first (cryptocurrency, utility token 482, or other) cryptographic token 833 and wherein the transient exchange rate information 231 established a remaining transaction time 763 (“T”);

transistor-based circuitry (e.g. a remote or other instance of an input processing module 883 or local invocation module 887 thereof) configured to receive the amount 751 of the second digital asset 733A into the first kiosk 220, 720 from a first user;

transistor-based circuitry (e.g. a remote or other instance of an association module 884 or local invocation module 887 thereof) configured to associate one or more security codes 236 with the amount 751 of the first cryptographic token 833;

transistor-based circuitry (e.g. a remote or other instance of a recognition module 885 or local invocation module 887 thereof) configured to begin a recipient vetting regimen 895 at a first start time 211A by obtaining recipient-qualifying information 216 from the first user wherein the first user becomes a qualified transaction participant 210 by providing the recipient-qualifying information 216;

transistor-based circuitry (e.g. a remote or other instance of a dispensation module 886 or local invocation module 887 thereof) configured to dispense to the qualified transaction participant 210 at the first kiosk 220, 720 a physical or other voucher 777 identifying the one or more security codes 236 in association with the amount 751 of the first cryptographic token 833 as a component of a first inchoate transaction 734A;

transistor-based circuitry (e.g. a remote or other instance of an implementation module 888 or local invocation module 887 thereof) configured to complete the recipient vetting regimen 895 at a first end time 211B by receiving last recipient-qualifying information 216; and

transistor-based circuitry (e.g. a remote or other instance of an output module 889 or local invocation module 887 thereof) configured to transform the first inchoate transaction 734A into a completed transaction 734B (at least partly) by authorizing a first transfer 756 of the amount 751 of the first digital asset 733B, wherein a difference 238 between the first start and end times 211A-B defines a prolonged recipient vetting duration 896 P>M, wherein M was established as a maximum transaction time 764.

37. The system of Clause 17, wherein (in respective variants) the system is configured to perform ANY of the above method clauses.

With respect to the numbered claims expressed below, those skilled in the art will appreciate that recited operations therein may generally be performed in any order. Also, although various operational flows are presented in sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. A method for enhancing security in one or more time-critical cryptographic token transactions by prolonging a recipient vetting thereof, the method comprising:
prompting an identification of first and second digital assets at a first kiosk by invoking transistor-based circuitry configured to prompt said identification of said first and second digital assets at said first kiosk;
presenting at said first kiosk first transient exchange rate information that indicates a first transient exchange ratio R1 between a first amount D1 of said first digital asset offered via said first kiosk and a transiently corresponding first amount D2 of said second digital asset to be obtained via said first kiosk by invoking transistor-based circuitry configured to present at said first kiosk said first transient exchange rate information that indicates said first transient exchange ratio R1 between said first amount D1 of said first digital asset offered via said first kiosk and said transiently corresponding first amount D2 of said second digital asset to be obtained via said first kiosk, wherein said first digital asset comprises a first cryptographic token, wherein said first transient exchange rate information established a remaining exchange rate time T within which said first transient exchange ratio R1 is applicable, and wherein said remaining transaction exchange rate time T within which said first transient exchange ratio R1 is applicable and said first transient exchange rate information that indicates said first transient exchange ratio R1 between said first amount D1 of said first digital asset offered via said first kiosk and said transiently corresponding first amount D2 of said second digital asset to be obtained via said first kiosk are both simultaneously presented on a screen display of said first kiosk;
obtaining a voltage configuration manifesting said transiently corresponding first amount D2 of said second digital asset corresponding to cash received from a first user into a bill acceptor of said first kiosk by invoking transistor-based circuitry configured to receive said voltage configuration manifesting said first amount D2 of said second digital asset from said bill acceptor;
associating one or more security codes with said first amount D1 of said first cryptographic token by invoking transistor-based circuitry configured to associate said one or more security codes with said first amount D1 of said first cryptographic token;
beginning a first recipient vetting regimen at a first start time by obtaining first recipient-qualifying information from said first user wherein said first user becomes a first qualified transaction participant by providing said first recipient-qualifying information by invoking transistor-based circuitry configured to begin said first recipient vetting regimen at said first start time by obtaining said first recipient-qualifying information from said first user wherein said first user becomes a first qualified transaction participant by providing said first recipient-qualifying information;
dispensing to said first qualified transaction participant at said first kiosk as a conditional response to said qualified transaction participant acknowledging said transient exchange ratio R1 a physical voucher identifying said one or more security codes in association with said first amount D1 of said first cryptographic token as a first component of a first inchoate transaction by identifying a record that establishes said one or more security codes in association with said first amount D1 of said first cryptographic token by invoking transistor-based circuitry configured to dispense to said first qualified transaction participant at said first kiosk said physical voucher identifying said one or more security codes in association with said first amount D1 of said first cryptographic token as said first component of said first inchoate transaction by identifying said record that establishes said one or more security codes in association with said first amount D1 of said first cryptographic token;
completing said first recipient vetting regimen by receiving last recipient-qualifying information by invoking transistor-based circuitry configured to complete said first recipient vetting regimen at a first end time; and
transforming said first inchoate transaction into a completed transaction by authorizing a first transfer of at least a portion of said first amount D1 of said first digital asset to a cryptographic wallet of said first qualified transaction participant and by recording said first transfer onto numerous cryptographic mining systems manifesting a public blockchain using said one or more security codes after completing said first recipient vetting regimen at said first end time by invoking transistor-based circuitry configured to transform said first inchoate transaction into said completed transaction by authorizing said first transfer of at least said portion of said first amount D1 of said first digital asset to said cryptographic wallet of said first qualified transaction participant and by recording said first transfer onto numerous cryptographic mining systems manifesting said public blockchain after completing said first recipient vetting regimen at said first end time, wherein said first recipient vetting regimen includes obtaining additional recipient-qualifying information after obtaining said first recipient-qualifying information and before obtaining said last recipient-qualifying information, wherein a difference between said first start and end times define a prolonged first recipient vetting duration P>M, wherein M was established as a maximum exchange rate time less than 15 minutes and such that T<M, wherein said additional recipient-qualifying information includes a component of a know-your-customer (KYC) protocol and a component of an anti-money-laundering (AML) protocol, wherein a difference between start and end times of said KYC protocol defines a prolonged KYC vetting duration>M and longer than an hour, and whereby said one or more time-critical cryptographic token transactions occur without a recipient thereof using said kiosk and even without said first recipient vetting regimen being performed upon said first qualified transaction participant.

2. (canceled)

3. The method of claim 1, wherein said invoking said transistor-based circuitry configured to transform said first inchoate transaction into said completed transaction comprises:
performing said recipient vetting regimen upon a human recipient within said prolonged first recipient vetting duration; and
authorizing said first transfer to said human recipient, wherein a probabilistic regimen component selection of said recipient vetting regimen is made possible by said prolonged first recipient vetting duration.

4. (canceled)

5. The method of claim 1, comprising:
identifying some other individual as a substitute recipient in said first transfer of said amount of said first digital asset as a conditional response to a vetting regimen finding fault with said qualified transaction participant; and
vetting that other individual after identifying that other individual.

6. A method for enhancing security in one or more cryptographic token transactions by prolonging a recipient vetting thereof, the method comprising:
prompting an identification of first and second digital assets at a first kiosk by invoking transistor-based circuitry configured to prompt said identification of said first and second digital assets at said first kiosk;
presenting at said first kiosk first transient exchange rate information that indicates a first transient exchange ratio R1 between a first amount D1 of said first digital asset offered via said first kiosk and a transiently corresponding first amount D2 of said second digital asset to be obtained via said first kiosk by invoking transistor-based circuitry configured to present at said first kiosk said first transient exchange rate information that indicates said first transient exchange ratio R1 between said first amount D1 of said first digital asset offered via said first kiosk and said transiently corresponding first amount D2 of said second digital asset to be obtained via said first kiosk, wherein said first digital asset comprises a first cryptographic token, wherein said first transient exchange rate information established a remaining exchange rate time T within which said first transient exchange ratio R1 is applicable, and wherein said remaining transaction exchange rate time T within which said first transient exchange ratio R1 is applicable and said first transient exchange rate information that indicates said first transient exchange ratio R1 between said first amount D1 of said first digital asset offered via said first kiosk and said transiently corresponding first amount D2 of said second digital asset to be obtained via said first kiosk are both simultaneously presented on a screen display of said first kiosk;
obtaining a voltage configuration manifesting said transiently corresponding first amount D2 of said second digital asset corresponding to cash received from a first user into a bill acceptor of said first kiosk by invoking transistor-based circuitry configured to obtain said voltage configuration manifesting said transiently corresponding first amount D2 of said second digital asset from said bill acceptor;
associating one or more security codes with said first amount D1 of said first cryptographic token by invoking transistor-based circuitry configured to associate said one or more security codes with said first amount D1 of said first cryptographic token;
beginning a first recipient vetting regimen at a first start time by obtaining first recipient-qualifying information from said first user by invoking transistor-based circuitry configured to begin said first recipient vetting regimen at said first start time by obtaining said first recipient-qualifying information from said first user wherein said first user becomes a first qualified transaction participant by providing said first recipient-qualifying information;
dispensing to said first qualified transaction participant at said first kiosk as a conditional response to said qualified transaction participant acknowledging said transient exchange ratio R1 a physical voucher identifying said one or more security codes in association with said first amount D1 of said first cryptographic token as a first component of a first inchoate transaction by identifying a record that establishes said one or more security codes in association with said first amount D1 of said first cryptographic token by invoking transistor-based circuitry configured to dispense to said first qualified transaction participant at said first kiosk said physical voucher identifying said first security code in association with said first amount D1 of said first cryptographic token as said first component of said first inchoate transaction;
completing said first recipient vetting regimen by receiving last recipient-qualifying information by invoking transistor-based circuitry configured to complete said first recipient vetting regimen at a first end time; and
transforming said first inchoate transaction into a completed transaction by authorizing a first transfer of at least a portion of said first amount D1 of said first digital asset to a cryptographic wallet of said first qualified transaction participant and by recording said first transfer onto numerous cryptographic mining systems manifesting a public blockchain using said one or more security codes after completing said first recipient vetting regimen at said first end time by invoking transistor-based circuitry configured to transform said first inchoate transaction into said completed transaction by authorizing said first transfer of at least said portion of said first amount D1 of said first digital asset and by recording said first transfer, wherein said first recipient vetting regimen includes obtaining additional recipient-qualifying information after obtaining said first recipient-qualifying information and before obtaining said last recipient-qualifying information, wherein a difference between said first start and end times define a prolonged first recipient vetting duration P>M, wherein M was established as a maximum exchange rate time less than one hour and such that T<M, wherein said additional recipient-qualifying information includes a component of a know-your-customer (KYC) protocol and a component of an anti-money-laundering (AML) protocol, and wherein a difference between start and end times of said KYC protocol defines a prolonged KYC vetting duration>M.

7. The method of claim 6, wherein said cash is transformed into said voltage configuration manifesting said transiently corresponding first amount D2 of said second digital asset within thirty seconds of said cash being received into said bill acceptor.

8. The method of claim 6, comprising:
establishing said maximum exchange rate time with an initial value less than 15 minutes before said physical voucher identifying said first security code in association with said first amount D1 of said first cryptographic token is dispensed to said first qualified transaction participant at said first kiosk.

9. The method of claim 6, wherein said invoking said transistor-based circuitry configured to transform said first inchoate transaction into said completed transaction by authorizing said first transfer and by recording said first transfer comprises:
transforming said first inchoate transaction into said completed transaction by authorizing a first transfer of at least a portion of said first amount D1 of said first digital asset to a cryptographic wallet of said first qualified transaction participant and by recording said first transfer onto numerous cryptographic mining systems manifesting a public blockchain after completing said first recipient vetting regimen at said first end time.

10. The method of claim 6, wherein said invoking said transistor-based circuitry configured to dispense to said first qualified transaction participant at said first kiosk said physical voucher identifying said one or more security codes in association with said first amount D1 of said first cryptographic token as said first component of said first inchoate transaction comprises:
dispensing to said first qualified transaction participant at said first kiosk said physical voucher identifying said one or more security codes in association with said first amount D1 of said first cryptographic token as said first component of said first inchoate transaction by identifying a record that establishes said one or more security codes in association with said first amount D1 of said first cryptographic token.

11. The method of claim 6, wherein said transaction participant is a recipient identified by said first and said last recipient-qualifying information, wherein said recipient vetting regimen includes obtaining first and last recipient-qualifying information relating to respective first and last components of an anti-money-laundering (AML) protocol performed upon one or more potential recipients of said first transfer of said amount of said first digital asset wherein a difference between said start and end times of said anti-money-laundering (AML) protocol defines a prolonged AML vetting duration>M, and wherein recording said first transfer of said first amount D1 of said first digital asset is accomplished by triggering a recordation of said first transfer onto a public blockchain after completing said first recipient vetting regimen at said first end time.

12. The method of claim 6, wherein said invoking said transistor-based circuitry configured to dispense to said qualified transaction participant at said kiosk said voucher identifying said one or more security codes in association with said amount of said first cryptographic token comprises:
printing said one or more security codes identifying said one or more security codes in association with said amount of said first cryptographic token onto said voucher after presenting said transient exchange rate information that indicates said transient exchange ratio R1 between said amount of said first digital asset offered via said kiosk and said transiently corresponding amount of said second digital asset and said remaining exchange rate time both simultaneously on a screen display of said kiosk and after receiving said amount of said second digital asset into said kiosk from said first user.

13. The method of claim 6, wherein said authorizing said first transfer comprises:
authorizing a first transfer of an entirety of said first amount D1 of said first digital asset to a cryptographic wallet of said first qualified transaction participant, wherein said recipient vetting regimen includes obtaining first and last recipient-qualifying information relating to respective first and last components of a know-your-customer (KYC) protocol performed upon one or more potential recipients of said first transfer of said amount of said first digital asset, wherein a difference between said start and end times defines a prolonged KYC vetting duration>M, and wherein recording said first transfer of said first amount D1 of said first digital asset is accomplished by triggering a recordation of said first transfer onto a public blockchain after completing said first recipient vetting regimen at said first end time.

14. The method of claim 6, wherein said identifying said first security code in association with said first amount D1 of said first cryptographic token comprises:
identifying a record that establishes said first security code in association with said first amount D1 of said first cryptographic token.

15. The method of claim 6, wherein said voucher identifying said first security code in association with said first amount D1 of said first cryptographic token as a first component of a first inchoate transaction is dispensed to said first qualified transaction participant at said first kiosk as a conditional response to said first qualified transaction participant acknowledging said first transient exchange ratio R1.

16. The method of claim 6, wherein cash is transformed into said voltage configuration manifesting said transiently corresponding first amount D2 of the second digital asset within thirty seconds of being received into the bill acceptor of said first kiosk.

17. A system for enhancing security in one or more cryptographic token transactions by prolonging a recipient vetting thereof, the system comprising:
transistor-based circuitry configured to prompt an identification of first and second digital assets at a first kiosk;
transistor-based circuitry configured to present at said first kiosk first transient exchange rate information that indicates a first transient exchange ratio R1 between a first amount D1 of said first digital asset offered via said first kiosk and a transiently corresponding first amount D2 of said second digital asset to be obtained via said first kiosk, wherein said first digital asset comprises a first cryptographic token, wherein said first transient exchange rate information established a remaining exchange rate time T within which said first transient exchange ratio R1 is applicable, and wherein said remaining transaction exchange rate time T within which said first transient exchange ratio R1 is applicable and said first transient exchange rate information that indicates said first transient exchange ratio R1 between said first amount D1 of said first digital asset offered via said first kiosk and said transiently corresponding first amount D2 of said second digital asset to be obtained via said first kiosk are both simultaneously presented on a screen display of said first kiosk;
transistor-based circuitry configured to obtain a voltage configuration manifesting said transiently corresponding first amount D2 of said second digital asset corresponding to cash received from a first user into a bill acceptor of said first kiosk;
transistor-based circuitry configured to associate one or more security codes with said first amount D1 of said first cryptographic token;
transistor-based circuitry configured to begin a first recipient vetting regimen at a first start time by obtaining first recipient-qualifying information from said first user wherein said first user becomes a first qualified transaction participant by providing said first recipient-qualifying information;
transistor-based circuitry configured to dispense to said first qualified transaction participant at said first kiosk as a conditional response to said qualified transaction participant acknowledging said transient exchange ratio R1 a physical voucher identifying said first security code in association with said first amount D1 of said first cryptographic token as a first component of a first inchoate transaction by identifying a record that establishes said one or more security codes in association with said first amount D1 of said first cryptographic token;
transistor-based circuitry configured to complete said first recipient vetting regimen at a first end time by receiving last recipient-qualifying information; and
transforming said first inchoate transaction into a completed transaction by authorizing a first transfer of at least a portion of said first amount D1 of said first digital asset to a cryptographic wallet of said first qualified transaction participant and by recording said first transfer onto numerous cryptographic mining systems manifesting a public blockchain using said one or more security codes after completing said first recipient vetting regimen at said first end time
transistor-based circuitry configured to transform said first inchoate transaction into a completed transaction by authorizing a first transfer of at least a portion of said first amount D1 of said first digital asset to a cryptographic wallet of said first qualified transaction participant and by recording said first transfer onto numerous cryptographic mining systems manifesting a public blockchain using said one or more security codes after completing said first recipient vetting regimen at said first end time, wherein said first recipient vetting regimen includes obtaining additional recipient-qualifying information after obtaining said first recipient-qualifying information and before obtaining said last recipient-qualifying information, wherein a difference between said first start and end times define a prolonged first recipient vetting duration P>M, wherein M was established as a maximum exchange rate time less than one hour and such that T<M, wherein said additional recipient-qualifying information includes a component of a know-your-customer (KYC) protocol and a component of an anti-money-laundering (AML) protocol, and wherein a difference between start and end times of said KYC protocol defines a prolonged KYC vetting duration>M.

18. A system of claim 17, wherein said transistor-based circuitry all resides at one or more servers remote from said first kiosk.

19. A system of claim 17, further comprising:
said first kiosk.

20. The method of claim 1, wherein said first recipient vetting regimen includes obtaining a criminal background check as a component thereof.

21. The method of claim 1, wherein said authorizing said first transfer of said amount D1 of the first digital asset includes identifying a human recipient of said first transfer and wherein said human recipient is not the qualified transaction participant.

22. The method of claim 1, wherein said know-your-customer (KYC) protocol and said anti-money-laundering (AML) protocol are components of a prolonged recipient vetting that takes longer than an hour and that is necessary for a first recipient associated with the first inchoate transaction.
